(19) United States
(12) Patent Application Publication
(10) Pub. No.: US 2016/0088809 A1
(43) Pub. Date: Mar. 31, 2016

(54) METHODS OF CANNABIS CULTIVATION USING A CAPILLARY MAT

(71) Applicant: MJAR Holdings, LLC, Miami, FL (US)

(72) Inventors: James Lowe, Denver, CO (US); Benjamin Franz, Denver, CO (US); Matthew Curran, Denver, CO (US)

(73) Assignee: MJAR HOLDINGS, LLC, Miami, FL (US)

(21) Appl. No.: 14/871,926

(22) Filed: Sep. 30, 2015

Related U.S. Application Data
(60) Provisional application No. 62/057,974, filed on Sep. 30, 2014.

(51) Int. Cl. A01G 31/00; A01G 1/00

(52) U.S. Cl. CPC A01G 31/001; A01G 1/001

(57) ABSTRACT

The present disclosure provides methods for cannabis cultivation using a capillary mat where the capillary mat is capable of simultaneously irrigating cannabis plants and delivering a selected set of nutrients under controlled and reproducible conditions to provide plasticity to express substantially the same cannabinoid components within the cannabis plants.

### CROSS-REFERENCE TO OTHER APPLICATIONS

This application claims priority to U.S. Provisional Application Ser. No. 62/057,974, filed Sep. 30, 2014, which is incorporated herein by reference in its entirety.

### FIELD OF THE INVENTION

The present disclosure provides methods for cannabis cultivation using a capillary mat where the capillary mat is capable of simultaneously irrigating cannabis plants and delivering nutrients under controlled and reproducible conditions to provide plasticity to express substantially the same cannabinoid components within the cannabis plants.

### BACKGROUND

Plants of the family Cannabaceae possess commercial value and have many uses and applications which arise from the natural products that are extracted from their flowers. For instance, hopps are extracted from the flowers of humulus plants in this family. Hemp has multiple uses, including food and as a fiber for making clothing, rope, etc. Cannabis has long been considered to have medicinal properties. Many states, such as Colorado, Washington, Oregon, California, Alaska, Maine, Hawaii, Nevada, Vermont, Montana, Rhode Island, New Mexico, Michigan, New Jersey, allow the use of medicinal cannabis by persons with debilitating medical conditions as certified by physicians.

Cannabinoids, which are compounds derived from cannabis, are a group of chemicals from Cannabis species, including Cannabis sativa, Cannabis ruderalis, and Cannabis indica plant that are known to activate cannabinoid receptors (i.e., CB1 and CB2) in cells. There are at least 85 different cannabinoids that can be isolated from cannabis. Cannabinoids are also produced endogenously in humans and other animals and are termed endocannabinoids. Synthetic cannabinoids are manmade chemicals with the same structure as plant cannabinoids or endocannabinoids.

Cannabinoids are cyclic molecules exhibiting particular properties such as the ability to easily cross the blood-brain barrier, weak toxicity and few side effects. The most notable cannabinoids are Δ9-Tetrahydrocannabinol (i.e., THC) and cannabidiol (i.e., CBD).

Some of the medical benefits attributable to one or more of the cannabinoids isolated from cannabis include treatment of pain, nausea, AIDS-related weight loss and wasting, multiple sclerosis, allergies, infection, depression, migraine, bipolar disorders, hypertension, post-stroke neuroprotection, epilepsy, fibromyalgia, as well as inhibition of tumor growth, angiogenesis and metastasis. Studies have shown that cannabinoids may also be useful for treating conditions such as glaucoma, Parkinson's disease, Huntington's disease, migraines, inflammation, Crohn's disease, dystonia, rheumatoid arthritis, emesis due to chemotherapy, inflammatory bowel disease, atherosclerosis, posttraumatic stress disorder, cardiac reperfusion injury, prostate carcinoma, and Alzheimer's disease. For example, U.S. Pat. No. 6,630,507 discloses cannabinoids for use as antioxidants and neuroprotectants; U.S. Pat. No. 7,105,685 discloses cannabinoids for the treatment of diseases associated with immune dysfunction, particularly HIV disease and neoplastic disorders; U.S. Pat. No. 7,109,245 discloses cannabinoids useful as vasoconstrictors; U.S. Pat. Publication US2011/0257256 discloses THC-CBD composition for use in treating or preventing Cognitive Impairment and Dementia; PCT Publication WO/2009/147439 discloses use of cannabinoids in the manufacture of a medicament for use in the treatment of cancer, in particular the glioma tumor; PCT Publication WO/2007/148094 discloses use of cannabinoids composition for the treatment of neuropathic pain; and U.S. Pat. Publication US2010/0286098 discloses a method of treating tissue injury in a patient with colitis administering the cannabinoids.

While such a wide range of medical uses have been identified, the benefits achieved by cannabinoids for a particular disease or condition are believed to be attributable to a subgroup of cannabinoids or to individual cannabinoids. That is to say that different subgroups or single cannabinoids have beneficial effects on certain conditions, while other subgroups or individual cannabinoids have beneficial effects on other conditions. For example, THC is the main psychoactive cannabinoid produced by Cannabis and is well characterized for its biological activity and potential therapeutic application in a broad spectrum of diseases. CBD, another major cannabinoid constituent of Cannabis, acts as an inverse agonist of the CB1 and CB2 cannabinoid receptors. CBD is a phytocannabinoid and, unlike THC, does not produce psychoactive effects in humans. CBD is reported to exert analgesic, antioxidant, anti-inflammatory, and immunomodulatory effects.

To date, however, medicinal marijuana is used as a generic product whereby the patient utilizes the entirety of the different cannabinoids to achieve medicinal results. Efforts have been made to maximize the medicinal benefit of cannabis for a patient having a particular condition, but such efforts are invariably complicated. For example, cannabis employed by a patient lacks consistent cannabinoid components and concentrations, and thereby fails to provide the maximum benefit to the patient.

Traditional cultivation methods for cannabis plants are based on a large-scale facility with an automatic watering arrangement and hydroponics-like cultivation channels to achieve automatically controlled cultivation management. The arrangement of the cultivation facility is simply employing mechanical devices to facilitate the management of plant cultivation. As a result, the overall cost of production is extremely high, and the success rate of actual cultivation of a desirable cannabis plant, which reproducibly expresses certain cannabinoid components, is difficult to impossible to control. In addition, the traditional cultivation methods for cannabis plants can result in problems in management operation when different cannabis cultivars at different growth stages are cultivated in the same space.

Traditional cultivation methods for cannabis and other members of the Cannabaceae family cannot provide consistent cultivation conditions such that the desired products are reproducibly expressed from the same strain or cultivar. Thus, there is an unmet need to provide methods for cultivating Cannabaceae under controlled conditions to ensure increased productivity and quality of the products derived from the plants, e.g., cannabis strains that reproducibly express and produce the desired cannabinoids, while at the same time further enhancing the technology and value of large-scale cultivation of cannabis.

The present disclosure relates to a comprehensive cultivation method using a capillary mat, which acts synergistically in coordination with other cultivation methodologies to increase yield potential, accuracy of yield predictions, as well as to optimize uniformity and maximize quality. The present disclosure provides a unique competitive advantage to cultivate cannabis plants, which reproducibly express substantially the same cannabinoid components from one plant to another.

### SUMMARY OF THE INVENTION

The present disclosure provides for a method for cultivating cannabis under conditions wherein the cannabinoid components expressed by a cannabis plant are subject to plasticity, wherein the method comprises irrigating the cannabis plant using a capillary mat, wherein the capillary mat is capable of simultaneously irrigating the cannabis plant and delivering a selected set of nutrients for cultivation to the cannabis plant, wherein variation of the selected set of nutrients or concentration of the selected set of nutrients is provided under controlled and reproducible conditions by the capillary mat so as to provide plasticity to express substantially the same cannabinoid components within the cannabis plant.

This invention is directed to ensuring reproducibility of, and adjusting the yield and concentration of, cannabinoids and other potentially therapeutic products (e.g., terpenes) produced from one crop to another crop of marijuana. However, the invention is also directed to ensuring the reproducibility and maximum yield of natural products from Cannabaceae plants from one crop to the next. Notwithstanding, the invention will begin with a focus on cannabis. In this regard, such reproducibility and controllability, in turn, relates to ensuring predictability in flowering duration, uniformity, and yield potential. Many morphological characteristics heavily influence growth characteristics of cannabis plants. These growth characteristics play a role in how cannabis cultivars compete with one another for space, light, water, and other resources.

In some embodiments, the method for cultivating cannabis further comprises delivering a selected set of nutrients for cultivation to the cannabis plant using the capillary mat.

In some embodiments, the variation of the selected set of nutrients or concentration of the selected set of nutrients is provided to increase cannabinoid content while lowering THC content within the cannabis plant.

In some embodiments, the method for cultivating cannabis further comprises using the capillary mats to maintain an optimal pH within a growth media of the cannabis plant.

In some embodiments, the method for cultivating cannabis further comprises using the capillary mat for flushing a growth media of the cannabis plant.

In some embodiments, the variation of the selected set of nutrients comprises providing nutrients at levels varying from deficient to excessive.

In some embodiments, the method for cultivating cannabis further comprises irrigating the cannabis plant from above a growth media of the cannabis plant at regular intervals.

In some embodiments, irrigating the cannabis plant from above the growth media of the cannabis plant comprises providing a solution above the growth media with a nutrient concentration less than that being provided by the capillary mat.

In some embodiments, irrigating the cannabis plant using a capillary mat comprises providing water to the cannabis plant in pulsed durations.

In some embodiments, the method for cultivating cannabis further comprising control of fungal and pathogen proliferation within the capillary mat.

In some embodiments, the average amount of water per day irrigated by the capillary mat is between about 0.2 gallons/square foot and 0.4 gallons/square foot.

In some embodiments, the capillary mat comprises cotton, wool, polyethylene or polypropylene.

### BRIEF DESCRIPTION OF THE DRAWINGS

Provided as embodiments of this disclosure are drawings which illustrate by exemplification only, and not limitation, wherein:

FIG. 1 depicts a reference chart for feed strength involving fertilization consumption ranges, nutrient supply and concentration, and yield maximum of plants.

Some or all of the figures are schematic representations for exemplification; hence, they do not necessarily depict the actual relative sizes or locations of the elements shown. The figures are presented for the purpose of illustrating one or more embodiments with the explicit understanding that they will not be used to limit the scope or the meaning of the claims that follow below.

### DETAILED DESCRIPTION

It is to be understood that the present disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

The detailed description of the present disclosure is divided into various sections only for the reader's convenience and disclosure found in any section may be combined with that in another section. Unless defined otherwise, all technical and scientific terms used herein have the same meaning as commonly understood by one of ordinary skill in the art to which the present disclosure belongs.

### DEFINITIONS

It must be noted that as used herein and in the appended claims, the singular forms “a”, “an”, and “the” include plural referents unless the context clearly dictates otherwise. Thus, for example, reference to “a compound” includes a plurality of compounds.

Unless defined otherwise, all technical and scientific terms used herein have the same meaning as commonly understood by one of ordinary skill in the art to which the present disclosure belongs. As used herein the following terms have the following meanings.

As used herein, the term “About” when used before a numerical designation, e.g., temperature, time, amount, concentration, and such other, including a range, indicates approximations which may vary by (+) or (−) 10%, 5% or 1%.

As used herein, the term “Comprising” or “Comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the present disclosure. “Consisting of” shall mean excluding more than trace elements of other ingredients and substantial method steps. Embodiments defined by each of these transition terms are within the scope of the present disclosure.

As used herein, the term “Plasticity” refers to the adaptability of a cannabis plant to changes in its environment or differences between various cultivation methods.

As used herein, the term “Substantially” is intended to indicate a range of up to about 20% of any value indicated.

As used herein, the term “Cannabis,” “Cannabis species,” or “Marijuana” refers to a flowering plant including the species (or sub-species) Cannabis sativa, Cannabis ruderalis, and Cannabis indica.

As used herein, the term “Cannabinoids” refers to a class of chemical compounds that act on the cannabinoid receptors. As used herein, the term “Endocannabinoids” are produced naturally in animals, including humans. As used herein, the term “Phytocannabinoids” are naturally-occurring cannabinoids produced in plants. As used herein, the term “Synthetic cannabinoids” are artificially manufactured cannabinoids.

Cannabis species express at least 85 different phytocannabinoids, which are concentrated in resin produced in glandular trichomes. The phytocannabinoids are divided into subclasses based on, including cannabigerols, cannabichromenes, cannabidiols, tetrahydrocannabinols, cannabinols and cannabinodiols, and other cannabinoids.

Cannabinoids found in cannabis include, without limitation: cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabinolic acid (THCA), and tetrahydrocannabivarinic acid (THCVA). Phytocannabinoids and their structures are discussed in more detail in U.S. Patent Application Pub. No. 2013/0059018, which is incorporated herein by reference in its entirety.

Phytocannabinoids can occur as either the pentyl (5 carbon atoms) or propyl (3 carbon atoms) variant. The propyl and pentyl variants may have distinct properties from one another. For example, THC is a CB1 receptor agonist, whereas the propyl variant THCV is a CB1 receptor antagonist meaning that it has almost opposite effects from THC.

“Cannabis components” as used herein include any therapeutic or potentially therapeutic compounds produced by or found in the cannabis plant and/or products thereof. Cannabis components include, but are not limited to, cannabinoids and terpenes.

As used herein, the term “Products of cannabis” refers to any products derived from the cannabis plant, including but not limited to the flower, resin (hashish), and oil (hash oil), as well as any preparations thereof. Preparations include, by way of non-limiting example, dried flower, kief, hashish, tincture, hash oil, infusions, pipe resins, edibles, and the like.

As used herein, the term “Yield potential” refers to the grams of product per square foot of cultivation space expected to be generated by a given cannabis strain or cultivar over a period of time. In some embodiment, the period of time is the time from propagation to harvest of a cannabis plant or batch.

The term “life cycle” as used herein refers to the progression of a plant through various stages of growth. Cannabis plants go through a vegetative stage of growth, followed by a flowering cycle. The period of growth between germination or cutting rooting and flowering is known as the vegetative phase of plant development. Vegetation is the sporophytic state of the Cannabis plant. Plants do not produce resin or flowers during the vegetative stage and are bulking up to a desired production size for flowering. During the vegetative phase, plants are busy carrying out photosynthesis and accumulating resources that will be needed for flowering and reproduction.

As used herein, the term “Flowering cycle” or “Flowering stage” (also called “bud cycle”) refers to the period during which the plant produces buds and flowers. This is the reproductive phase of plant growth. Cannabis is dioecious having female and male reproduction parts on separate plants. Flowering is the gametophytic or reproductive state of Cannabis. For production, only female flowers are selected for cultivation. For some cultivars, the switch from the vegetative stage to the flowering stage is light-dependent. Some cultivars are auto-flowering, meaning they switch to the flowering stage automatically (e.g., with age).

“Vegetation cycle” or “vegetative phase” refers to the period of growth between germination or cutting rooting. Vegetation is the sporophytic state of the cannabis plant. This is a form of asexual reproduction in plants during which plants do not produce resin or flowers. The plant is bulking up biomass to a desired production size for flowering. During the vegetative phase, plants are busy carrying out photosynthesis and accumulating resources that will be needed for flowering and reproduction.

As used herein, the term “Cannabis cultivar” and “Cannabis strain” are used interchangeably, and refer to cannabis plants that have been selected for one or more desirable characteristics and propagated. Where the term cultivar or strain is used, it is to be understood that the cultivar or strain may be naturally-occurring, a result of breeding, and/or the result of genetic manipulation. Propagation may occur in any manner, including, without limitation, sexual reproduction (e.g., seed), cloning (e.g., cuttings, vegetative propagation), self-pollinization, and the like.

“Plants of the family Cannabaceae” as used herein refers to any member of the Cannabaceae family of plant organisms including, but not limited to, Celtis, Cannabis, and Humulus plants.

As used herein, the term “plurality” as used herein refers to more than one. For example, a plurality of cultivars may be two, three, four, five, or more cultivars.

### Fertilizer, Irrigation, and Fertigation Management

The present disclosure relates to technologies and methods relating to nutrient and pesticide engineering to enhance the quality of premium cannabis. Cultivation technologies include, but are not limited to, capillary mat irrigation systems, self-manufactured fertilizers, fertilizer injectors, advanced lighting and benching technology, and organic non-toxic pesticide application technology.

The present disclosure also relates to fertilizer, irrigation, and fertigation management. Water and mineral nutrients are two inputs that are essential in any horticultural operation, and the management of the application of these substances can have a large influence on both yield and quality. There is a large variety of different ways these two substances can be applied to satisfy plant requirements. In some embodiments, they can be applied to a soil or soilless substrates (i.e., Coco coir, peat, etc.), in which case the soil or soilless substrate absorbs water and mineral nutrients and serves as a reservoir for these substances. In other embodiments, they can also be supplied in a hydroponic system, which provides constant direct access to water and mineral nutrients by flooding, misting, dripping, wicking, or direct submersion of roots.

Plant roots can either grow directly in solution, or into a substrate. If the plant is grown hydroponically in a substrate, it is referred to as “media based hydroponics.” It is typically classified as soilless production if the substrate has a high cation exchange capacity (and anion exchange capacity) and media based hydroponics when the substrate has little or no cation/anion exchange capacity. Examples of hydroponic substrates include, but are not limited to, vermiculite, perlite, expanded clay pellets, and rockwool (stone wool).

There are many different ways in which water and fertilizer can be distributed, applied, and circulated throughout large scale commercial cultivation operations. The distribution of water to plant roots is referred to as “irrigation”, while the application of fertilizers or other chemicals and water together in the same solution is referred to as “fertigation”. In some embodiments, fertigation and irrigation systems collect runoff fertilizer solution, and recirculate this reclaimed solution to the plants. These systems are referred to as “recirculating” fertigation/irrigation systems. In some embodiments, systems that disregard runoff fertilizer solutions are referred to as “drain to waste” fertigation/irrigation systems. If the water or fertilizer solution is provided to the top of the substrate, it is referred to as “overhead” irrigation/fertigation. If the water or fertilizer solution is provided from below the substrate, it is referred to as “subsurface irrigation.”

Each different combination of substrate, irrigation system type, and application method has a large influence on the ideal chemical characteristics of the fertilizer solution. The two major components of a fertilizer solution are: the overall concentration of minerals nutrients, and the ratios of mineral nutrients with respect to one another. In addition to the above system characteristics, there are many other factors which may influence the ideal values for both the total concentration, and mineral nutrient ratios of the fertilizer solution. These factors include, but are not limited to, temperature, relative humidity, vapor pressure deficit (or gradient), wind speed, plant fertility status, light intensity, light quality, plant age, genetics, stage of growth (vegetative, flowering), and fertilizer solution temperature.

The present disclosure uses a variety of different technologies and processes to manage irrigation and fertilizer needs of Cannabis to: increase fertilizer efficiency, reduce fertilizer “dumping”, increase labor efficiency, increase space efficiency, increase yields, increase uniformity and replicability, and reduce fertilizer costs. The following technologies/processes are implemented by the present disclosure for the efficient distribution of water and fertilizers: capillary mats, ebb and flood benching, fertilizer injectors, and fertilizer manufacturing processes.

### Capillary Mats in Cannabis Production

The use of capillary mats in commercial Cannabis production is extremely rare. In relation to other irrigation/fertigation system types, the capillary mats provide many unique benefits that are undiscovered by other cultivators.

Capillary mats operate be supplying water and fertilizer from below the substrate. Fertilizer solution is dripped into a “capillary layer” by drippers or drip tape. The capillary layer conducts the fertilizer solution throughout the mat. As plants remove moisture from the substrate, water moves by osmosis through the mat, and capillary action and root hydraulic conductance draws water into the pot. Irrigation/fertigation events provide water to the capillary mat to replace water removed by the pots. There are many benefits to this irrigation system type, relative to other irrigation system types.

First, the system can run with much smaller amount of water storage (or no water storage). The capillary mat serves as a reservoir for water (and fertilizer), so only small increments of water are needed to feed the system. With hydroponic systems, much larger amounts of water storage are needed on site to accommodate the large demand. By using capillary mats, the amount of water storage needed on site is significantly diminished. This aids in facility layout efficiency, as much smaller amounts of space are needed for water storage, so this space can be reallocated as flowering or vegetative benching. Also, the peak water demand is significantly diminished, as many large tanks do not need to be refilled simultaneously as spent recirculating tanks are dumped.

Secondly, capillary mats consume less water and fertilizer than overhead irrigation system types (hand water, drip). The amount of water consumed in capillary mat facilities is on average, 15-25% less than in hand water facilities. Additionally, the concentration of fertilizer in solution is reduced by 25-50%, compared to overhead irrigation (drip, hand water). The combination of reduced fertilizer concentration and reduced water consumption reduces overall fertilizer consumption by >60%.

In addition to savings in space, fertilizer, and water; capillary mat irrigation systems also reduce labor by up to 50%. Water and fertilizer can be distributed to plants much more efficiently, so less labor is required for plant fertigation events. It can also be done automatically with timers or other mechanisms, which can help accommodate unusual facility light schedules, and allow proper irrigation timing in the absence of manager supervision.

Another important benefit to capillary mats is watering uniformity. With overhead irrigation, the water is forced into the root zone from the top. Although this typically does not cause problems for the plant, there are instances where this can cause plant health issues. If there are too frequent of irrigation events with overhead irrigation, this can deplete oxygen in the root zone. As oxygen is depleted, this causes multiple plant health problems such as, ammonium toxicity, calcium deficiency, and increased chance of root infection from pathogens.

With subsurface irrigation system types, the plant is only able to wick the amount of water it needs, and helps resist the oversaturation of the substrate. This helps reduce the instances of “overwatering” symptoms. This is of great benefit in indoor cultivation areas, as there are typically large stratifications of air flow, temperature, and light intensity. The environmental stratification of indoor cultivation environments (microclimate) causes differing water needs between plants in the same irrigation zone. Subsurface irrigation allows you to be able to water the same group of plants with differing watering needs, without causing problems related to overwatering. It also allows the comingling of different Cannabis varieties with varying watering needs in an irrigation zone, without adverse health effects in certain plants in an irrigation zone. This allows cultivators to increase genetic diversity in an irrigation zone to accommodate retail demand.

Another important benefit to capillary mat watering systems is that it is relatively failsafe. With drip irrigation systems, drippers have the possibility of clogging, or being pulled out of their substrate as workers move throughout the cultivation areas. This can lead to plant death, as the cultivation manager might not be able to notice the problem before it is too late. With capillary mat watering systems, as long as the plant is sitting on the mat, it will be able to receive water. If individual drip emitters in the mat clog, water is able to be conducted through the capillary layer to these areas of the mat to help prevent issues.

With hydroponic systems, a pump failure can mean plant death within a few hours. With capillary mat irrigation systems, the substrate and the mat have a large ability to hold a reservoir of water. Plants can go 2-3 days without an irrigation event, and survive. This extends the margin of error possible, without economic losses resulting from equipment failure.

Another consideration in irrigation/fertigation system choice is fertilizer runoff and dumping. With drain to waste systems, fertilizer solution is dumped to waste on a daily basis. In recirculating systems, the same fertilizer solution is reused multiple times. Over time, the ratios of mineral nutrients become unbalanced, and needs to be discarded.

The capillary mat irrigation systems are in the middle of these two extremes. It has a much smaller amount of runoff that other drain to waste systems. Additionally, there is no fertilizer dumping associated

In some embodiments, capillary mats are with rolling top tables. Although rolling top tables have numerous benefits, there are a few drawbacks with the hydroponic systems. As the bench rolls into an aisle, the outside edge of the bench sags between 1 and 3 inches. This can cause problems with hydroponic systems, as it can cause uneven water distribution. Additionally, the benches cannot accommodate the amount of weight of water present in some types of hydroponic systems without tipping. This limits the type of irrigation system that is compatible with rolling top bench systems.

Capillary mat systems work very well with rolling top tables. The capillary mat system is very forgiving of slight differences in pitch caused by table sagging. Also, there is a smaller risk of irrigation system malfunction, compared to drip systems. As the table rolls back and forth, and workers move throughout aisles, there is a large risk of emitters being removed from their substrate, which can cause potential plant death. There is also a smaller, more even distribution of weight. This prevents issues with the table ‘tipping’.

In some embodiments, the present disclosure relates to tank-less capillary mat systems. The vast majority of automated irrigation systems in Cannabis plant production areas utilize fertigation reservoirs in plant production areas. Chemicals are added to smaller “zone” tanks, and the zone tanks circulate the fertilizer solution to the plants. The size of the fertigation zone tank depends largely on the irrigation system type. Hydroponic, and other recirculating systems, typically require a much larger volume of water to supply the system. These water storage areas can capture large volumes of facility floor space, reducing the amount of production bench area.

With tank-less capillary mat systems, little to no water storage is required. Water directly from the city taps, or from a single central water storage tank, is delivered to fertigation zones. When the water reaches the desired fertigation zone, it passes through a series of fertilizer injectors. These injectors dose the proper amount of fertilizer for the recipe for that zone, so that the fertilizer EC, fertilizer ratios, and pH can be instantaneously injected. Since only small volumes of water need to be delivered to the system per irrigation event, there is never a large instantaneous water demand. With an irrigation control system, smaller tap sizes can be utilized by rotating which zones are being irrigated.

In some embodiments, the present disclosure relates irrigation control with soil moisture probes. Most automated irrigation systems utilize timers to set the timing and duration of irrigation events. With constant visual monitoring of substrate moisture for prevention of “overwatering’, this can be adequate to produce good quality plants. Plant substrate can become ‘overwatered’ from too frequent of irrigation events, if the timers are set incorrectly, or environmental variables change, the irrigation timing can become incorrect. Additionally, irrigation events may occur too frequently, or the duration might be too long, causing waste in water and fertilizer.

In some embodiments, a more sophisticated method to determine irrigation needs of the crop involves the use of soil moisture probes. Soil moisture probes measure the volumetric water content of the substrate, and triggers irrigation events based on soil moisture. This increases irrigation efficiency, as irrigation durations are reduced to only what is needed. This system also reduces the amount of oversight required to produce good quality plants.

The present disclosure also relates to a method of growing cannabis plants using a capillary mat in a hydroponic system to provide fertilizer and water to the plants, including a method of cleaning the capillary mats. The use of a capillary mat serves as a means for signaling the plants to reproducibly express substantially the same cannabinoid components from one plant to another plant of cannabis. The present technology can be thought of as a feedback loop between the plants and the capillary mat system.

Capillary mats relate to a type of subsurface irrigation require attention to frequency times and growth phase. Capillary mats provide a consistent and adequate level of moisture that allows for proper cannabis crown development and utilization of soil throughout all growth phases. Pots of a younger growth phase often require less watering frequencies than pots of later growth phases, especially during younger growth phases and times immediately following transplanting less soil is encompassed by roots. This increases the need for a stronger feed strength, such as capillary mats, which increase the duration between the wet and dry cycles of cannabis pots. The capillary mat system encourages root growth by cycling between a wet and drying out period. Root growth of cannabis plants can be inhibited by high substrate moisture, low humidity, low temperature, and low availability of CO₂ content. In some embodiments, the cannabis plants are watered and fed only by a capillary mat system, which gives temporal controls to promote root growth of cannabis plants.

During an irrigation event, the pots are wetted so that all of the soil space in saturated up to the last few centimeters of soil. Capillary mats do not allow the media to become dry on the upper portions of the rhizosphere, and thus allow proper cannabis crown development and root revitalization. Allowing the media to become dry on the upper portions of the rhizosphere promotes a salinity build-up, which does not allow for proper transpiration and can result in wilting plants. Thus, gauging the time of the water duration to achieve the described moisture level is required.

At earlier stages of growth, the duration between watering events is greater, which means that between watering events, the capillary mat has to be run to maintain capillary action between the rhizosphere and capillary mat. This watering event mainly maintains the moisture of the capillary mat. In later stages of growth, there are at least two daily watering events from the capillary mat. The first daily watering event is used to maintain the capillary mat moisture, and the second daily watering event is transitioned in the pot watering event. In some embodiments, the pots of cannabis plants are flushed on the capillary mat with a top water feed every eight (8) to ten (10) days. This is done with a solution feed strength slightly less concentrated than the normal feed, which promotes a healthy rhizosphere by ensuring salinity, oxygen content and moisture are proper at the crown and throughout all media.

In some embodiments, the pots of cannabis plants undergo a pulse-watering event in combination with the capillary mats. Pulse watering is a watering technique that takes one long irrigation time and breaks it up into several shorter durations that accumulate to the entire duration of the long irrigation time. Sources sight that watering demand is decreased through pulse watering by having water more available for a longer time. In some embodiments, low flow systems are utilized in combination with the capillary mats, and the emitter size is determined first by the flow restrictions of pumps and irrigation zoning. Low flow systems optimize water usage but require longer watering durations. Control the size of the emitters can provide the lowest possible flow that provide required amount of water over the longest possible time. In some embodiments, drip irrigation is also utilized in combination with the capillary mats.

In some embodiments, soil moisture is to reach a level that does not allow for drought stress to occur to any degree, thus water level at time of water should be minimum and not allow for any chance of over watering. In some embodiments, during watering event, the pots of cannabis plants are to be leeched at minimum two (2) to three (3) times its water holding capacity. The water holding capacity of the standardized mix is about 0.68 gals H₂O/gallon media. For three (3) gallons potted production, it means four (4) to six (6) gallons at each watering event per pot. For five (5) gallon potted production, it means 6.8 to 10.2 gallons at each watering event per pot. In some embodiments, during watering event, a pot needs to have water placed into the pot three (3) times. The pots are first wetted to provide capillary action to the soil, and water again to displace the old fertilizer mix with the new fertilizer mix. The pots are watered a third time to provide only the proper solution to the rhizosphere. In some embodiments, the pots are all made from the same breathable mesh.

In some embodiments, the exact pore size of the medium or substrate is critical to the potential growth of cannabis plants. The pore size directly correlates to calcium ion and water release from the medium or substrate, and the particular pore size corresponds to an increased uptake by the plants. Surprisingly and unexpectedly, the pots are always kept at full capacity and cannot be under or over-watered when the correct pore size of the substrate is chosen in combination with the capillary mat system.

In some embodiments, a capillary mat not only supplies a steady watering system, but more importantly, a precise, reproducible means of controlling the production of cannabinoid compounds of the plant. Desired characteristics of the plant have been adjusted by altering the timing, nutrient gradient (in the soil and rhizosphere), nutrient content and/or concentration, and residence time of the water supply in the capillary mat. This means of signal feedback with the plant is used in concert with the many other conditions that affect the growth and development of the plants. For instance, lighting plays a role in cannabis plant development. Lighting intensity, frequency, and duration could be varied in concert with adjustments in water and nutrients administered from the capillary mat at different stages of the plant's lifecycle to result in an increase in certain cannabinoids to THC ratio and overall cannabinoids yield. Specific cannabinoid compounds could also be favored according to adjustments with the capillary mat system and the administration of the nutrients. Exemplary methods of cultivating cannabis utilizing lighting technologies and methodologies to expose the plant to light of different intensities during the plant's life cycle are described in U.S. Pat. No. ______ (Atty Docket No. 107543-0451) filed Sep. 30, 2015 (claiming priority to U.S. Provisional Patent App. No. 62/058,045) and titled “METHODS OF GROWING CANNABACEAE PLANTS USING ARTIFICIAL LIGHTING.”

In some embodiments, the cannabis plants are irrigated using a capillary mat, which is capable of simultaneously irrigating the plants and delivering a selected set of nutrients for cultivation. The variation of the selected set of nutrients or concentration of the selected set of nutrients is provided under controlled and reproducible conditions by the capillary mat so as to provide plasticity to express substantially the same cannabinoid components within the cannabis plant. The cannabis plants can adaptively produce substantially the same cannabinoid components using the capillary mat system even if its environment changes or there are differences between various culturing conditions.

In some embodiments, the capillary mat system is capable of delivering a selected set of nutrients for cultivation to the cannabis plant. In some embodiments, the variation of the selected set of nutrients or concentration of the selected set of nutrients is provided to increase cannabinoid content while lowering THC content within the cannabis plant. In some embodiments, the variation or concentration of the selected set of nutrients is provided to increase CBD content while lowering THC content within the cannabis plant. In some embodiments, the capillary mat system maintains an optimal pH within a growth media of the cannabis plants, and enhances the development and growth of the roots of the cannabis plants. In some embodiments, the capillary mat system maintains pH for soil-based media at about 6.2 to about 6.8. In some embodiments, the capillary mat system maintains pH for soilless media at about 5.4 to about 6.0.

In some embodiments, the variation or concentration of the selected set of nutrients provided by the capillary mat system comprises providing nutrients at fertility values varying from deficient to excessive. Fertility Values include: a)<0.25—Deficient; b) 0.25-0.4—Hidden Hunger; c) 0.41-0.59—Optimal; d) 0.6-0.7—Luxury; e) 0.7-0.9—High; and f) >1.0—Excessive.

In some embodiments, the capillary mat system is used for flushing a growth media of the cannabis plants to keep an optimal cultivation condition. If the fertility value is excessive, the plants are flushed with RO water with 25-50% leeching, depending on severity, and the fertility value is retested and adjusted accordingly. If the fertility value is high, the mix strength is decreased 10-15% by adding water or making a new batch tank in capillary mats. If the fertility value is luxury, the mix strength is decreased 5-10% by adding water or making a new batch tank in capillary mats. If the fertility value is optimal, the feed strength is maintained. If the fertility value is hidden hunger, the mix strength is increased by 5-10% using capillary mats. If the fertility value is deficiency, the feed strength is increased by 10-15% using capillary mats.

In some embodiments, the method for cultivating cannabis further comprises irrigating the cannabis plant from above a growth media of the cannabis plant at regular intervals, such as a top water system. In some embodiments, irrigating the cannabis plant from above the growth media of the cannabis plant comprises providing a solution above the growth media with a nutrient concentration less than that being provided by the capillary mat.

In some embodiments, the method for cultivating cannabis further comprising control of fungal and pathogen proliferation within the capillary mat. In some embodiments, the average amount of water per day irrigated by the capillary mat is between about 0.2 gallons/square foot and 0.4 gallons/square foot.

In some embodiments, the capillary mat comprises cotton, wool, polyethylene or polypropylene. In some embodiments, the capillary mat material is a continuous loop of open weave textile material made from any one of a variety of fibers including nylon, acrylic, etc. A synthetic material can be used because of the improved capillary action, and acrylic is generally used because it has been found that acrylic delivers approximately 30 percent more of the nutrient fluid than does a nylon mat. In some embodiments, the capillary mat is provided in sheet form and the loose ends inserted for access to the nutrient fluids. In some embodiments, non-woven materials and/or natural fibers may also be utilized. In some embodiments, the capillary mat delivers a continuous supply of nutrient fluid by capillary action to the cannabis plants and to the developing plant root system.

Capillary mats are designed to be used with water, and as such are prone to scale and plague build-up when fertilizer solution is used. The build-up can quickly clog the capillaries. Cleaning is a challenge. The present disclosure provides for a cleaner, which is aggressive enough to remove build-up without eroding and destroying the capillaries.

The present disclosure includes, but not limited to, examples of certain variables that are adjusted (in concert with water and nutrients administration from the capillary mat) in order to express substantially the same cannabinoid components produced from the cannabis plants. These variables include, but are not limited to, irrigation systems, water quality and usage, soil composition, plant density, pot selection, nutrition and fertilizer salts, feed strength, and flushing.

Ebb and Flood Irrigation Systems with Palletized Trays

Large scale greenhouse production has many unique challenges, compared to 100% artificially illuminated intensive indoor production. As the scale of the operation increases, certain tasks become the limiting step to reduce labor hours in the operation. One of these labor tasks is the movement of plants throughout the cultivation operation.

Cannabis is a very fast growing crop. For optimal space utilization, the plant should be given adequate space (but not too much space) for a given size, age, and stage of growth. Additionally, having a separate vegetative area continually supplying flowering houses with a constant influx of flowering plants allows each of those flowering houses to achieve a greater amount of harvests per year, and the entire range produces more house harvests per year.

The optimization of space causes a large amount of plant movements throughout the greenhouse range. Harvesting plants, moving plants between stages in vegetative growth, and moving plants into flowering houses, creates a large demand for labor. Additionally, the large amount of workers in plant production areas serves as a vector for the transmission of pests and diseases between production areas. This further increases labor demand for the application of pesticides, and reduces yield.

In some embodiments, one method of both reducing labor associated with plant movements, and reducing the prevalence of worker mediated pest and disease transfer, is palletized benching systems. Palletized benching systems are rolling tray systems that allow the transportation of entire greenhouse benches between areas in the greenhouse. There are “tracks” in each greenhouse that the benches slide on, allowing the movement of a tray from one end of the house to the other. A “transport rail” sits at the end of these rows, and runs perpendicular to this rail system. The “transport rail” allows the tray to move between different houses, or back into head house areas. Trays have two sets of wheels on each tray—one set is aligned parallel to the “transport rail,” and one set is aligned perpendicular to “transport rail.” This allows the trays to move on both different sets of rails.

This system reduces the amount of laborers required to move the benches between areas in the greenhouse. Additionally, the reduction in the amount of laborers in the greenhouse reduces pest pressure associated with worker mediated pest and disease transfer. This also allows large sections of plants to be harvested from an area, and refilled from the vegetative house, so that there are no “gaps” in the production schedule.

In addition to improving operations from a reduction in labor and pest pressure, the palletized benching system is also an automated irrigation system. The palletized trays are a recirculating ebb and flood irrigation system. This provides many benefits to the operation including: reduced water usage, reduced fertilizer usage, and reduced labor.

### Fertilizer Injectors

Fertilizer injectors operate by dosing small amounts of concentrated fertilizers from “stock tanks” directing into water lines. This allows extremely precise dosing of fertilizer salts into water. This provides numerous benefits to the cultivation operation including: reduced fertilizer usage, increased labor efficiency, increased measurement accuracy and precision, and allows for computer controlled preparation of fertilizer solutions.

The present disclosure utilizes fertilizer injectors for multiple different applications include, but not limited to, tank-less capillary mat systems, computer automated fertigation systems, retrofit existing hand watering systems, and dose disinfectants, chelating agents, and specialty chemicals.

### Fertilizer Manufacturing

The majority of Cannabis cultivation operations utilize “hydro store” brand name nutrients. These fertilizers are extremely expensive, and many of them may contain hidden plant growth regulators, heavy metals, or other contaminants. Additionally, these brand name nutrients typically split the fertilizer profile between multiple different components. This makes implementation of the fertilizer brand with fertilizer injectors expensive and difficult, as many fertilizer injectors are needed to be maintained to supply the desired fertilizer profile.

By manufacturing the fertilizer from scratch, equivalent fertilizer products can be made, without the additional cost or risk of contaminants. The identical fertilizer salts contained in retail fertilizer concentrates can be purchased, and mixed in the appropriate ratios to produce fertilizer concentrates for use in production facilities. This offers numerous benefits to the cultivation operation including, but not limited to, reduced fertilizer cost, customized fertilizers, flexible concentrates, and simpler formulas that decrease the complexity and labor associated with running a particular fertilizer line.

Custom fertilizer blends can be created, as more information is available on the nutritional needs of different cultivars. Ratios can automatically be adjusted for cultivators to account for cultivar specific nutritional needs of Cannabis. Additionally, fertilizers can be adjusted based on the irrigation system type, water quality, or time of year. The flexibility of this method of fertility management makes it superior to other ways of managing plant fertility requirements.

### Irrigation Systems

The irrigation systems, which can be employed in addition to the capillary mat, consist of open systems and close systems. The open systems are systems where the irrigation/fertigation water is applied to the surface of the soil and allowed to drain from the bottom of a container grown plant. In some embodiments, the open system comprises hand watering, which is considered uneconomical in many circumstances today, but is permissible for high profit crops and high density planting. In some embodiments, the open system comprises a drip irrigation system. However, many drip irrigation systems provide uneven watering. Drip emitters and poly tubing can be utilized continuously, as well as pulse water throughout growth cycles. Media often dictate the emitter type and irrigation frequency because course substrate requires spray emitters to prevent channeling and higher frequencies of watering.

In some embodiments, the open system comprises a Fresh-Flower Watering system, which is also known as flood irrigation, utilizing a source of high volume water output, such as a flood ditch, trough or field irrigation tube, to flood the entire soil surface. In some embodiments, the open system comprises an overhead sprinklers and booms system. Perimeter watering utilizes sprinklers to project water from the edge of a bench to the root zone, which may dampen foliage. Booms and overhead sprinklers are to be utilized in situations where foliage is permitted to be wet. Booms and overhead sprinklers can provide irrigation through spray emitters, however not all cultivars or phases are tolerant. Booms and overhead sprinklers can be designed as a closed system.

The closed systems are systems where the irrigation/fertigation water is applied from the bottom of a container grown or hydroponic system. The close system comprises capillary mats, which utilize tubing and fabric mats, generally 3/16″-½″ in thickness. The close system comprises an Ebb and Flood system, which utilizes a level, enclosed benching system that allows for the subsurface irrigation of plants, including but not limited to draining the waste and recirculating systems, such as Under-Current Recirculating System and Flood Floor System.

In some embodiments, the close system comprises a Deep Water Culture system, in which roots of cannabis plants remain submerged in fertigation solution continuously. In some embodiments, the close system comprises a Nutrient Film Solution (NFT) system, which is a shallow, slightly graded trough system that utilizes the continuous, slow flow of water.

In some embodiments, the fertigation system is chosen because it uses a well-drained media, or it waters thoroughly each time, or it waters just prior to onset of moisture stress, or it avoids overwatering and under watering events.

### Water Quality

In some embodiments, cultivation water comes from three sources: 1) agricultural wells, 2) surface irrigation, and 3) municipal providers. Determining the source and testing the water used for irrigation is pivotal. Municipalities provide data regarding the source of water and quality. Water quality should be checked for temperature, alkalinity, acidity and hardness, dissolved salts, pH, and suspended solids.

Water temperature must be greater than about 68° F. and less than about 76° F. Water temperature should be examined before pH is adjusted and nutrients added. Alkalinity, acidity and hardness of water determine the initial pH of the irrigation water. Adjustments are made to feed the cannabis plants with water within the desired pH (i.e., about 5.5-5.9). Feed solution is adjusted after the addition of fertilizer. High pH water can sometimes indicate high amounts of carbonate and bicarbonates, which also indicate the hardness of the water. Acidifying water treatment (i.e., pH to <5.0) lasts for about thirty (30) to forty-five (45) minutes. Acidification of water assists in removal of carbonate and bicarbonates.

Examining the dissolved salts in irrigation water is crucial in knowing the initial Electrical Conductivity (EC) of irrigation water, which help determine the water filtration needs and adjustments to fertility. Determining the pH of the irrigation water and adjust to desired range is also important because pH down lowers the overall pH, and pH up increases the overall pH. After each addition of pH up or down, pH is allowed to reach equilibrium in thirty (30) minutes. Examining irrigation water for suspended solids and all other potential contaminates can be done by taking samples of any unusual contaminates in performing laboratory tests.

Purification can be achieved through many means, including but not limited to sediment filters, Reverse Osmosis (RO), UV filtration, heat pasteurization, chlorination, acidification, and hydrogen peroxide. Reverse Osmosis water does not have a pH but is neutral and balances between a constant state of H⁺ and ⁻OH ionic equilibrium. UV filtration utilizes a purely mechanical means of purifying water, for example, UV-C light can be used to denature bacterial DNA. Heat pasteurization occurs at over 170° Fahrenheit for water and 260° Fahrenheit for soilless media, which kills and denatures and potential pathogens and pests in the water/media.

Chlorination of water utilizes a halogen, chlorine, which is a disinfectant. Chlorine kills by oxidizing organic molecules and is effective on viruses, algae and other pathogens. Chlorine is to be used at 1 gram/gallon up to 2 grams/gallon. Acidification (i.e., pH to <5.0) lasts for about thirty (30) to forty-five (45) minutes, which assists in removal of carbonate and bicarbonates. Acidification puts the water in a pH range in which many organisms and pathogens cannot live. Acidification of water lasts for a minimum of thirty (30) minutes. For a large volume of water, a longer acidification period is required to provide agitation. Hydrogen Peroxide kills by oxidizing organic molecules, and is effective on viruses, algae and other pathogens.

### Water Usage

Water usage varies from site to site. Average water use ranges from 0.2 gal/square foot to 0.4 gal/square foot daily. Water storage is about 3-4 times the daily requirement. Facility piping and water filtration are sized to meet the demand. Facility mechanical are fertigation systems are considered when estimating and sizing water systems. Pad walls, drain to waste systems, overhead mist, boilers, sprinklers and various other systems require water. RO filtration system is sized to meet the demand.

Water usage also varies dependent on the time of year. The summer months are warmer, thus higher usage is expected. The winter months are cooler, thus lower usage is expected. In some embodiments, water-holding capacity of current mix is 0.68 gallons water per gallon media.

### Soil Composition

Soil Chemistry includes but is not limited to the following factors: a) Carbon-to-Nitrogen Ratio; b) Cation Exchange Capacity (CEC); c) pH; d) temperature; e) water holding capacity; and f) electrical conductivity. In some embodiments, the soil based mix has about a 30:1 Carbon to Nitrogen ratio. In some embodiments, the soil based mix requires the use of free nitrogen-fixing microorganisms. In some embodiments, media mixes with a high cation exchange capacity are desired. In some embodiments, media are negatively charged. In some embodiments, cation exchange capacity allows for media to retain desired nutrients. In some embodiments, pH of soil-based media is about 6.2 to about 6.8 (20% or more soil). In some embodiments, pH of soilless media is about 5.4 to about 6.0. In some embodiments, temperature of the soil remains constant, which may require heated water and bottom heat. In some embodiments, the preferred temperature of soil is between about 68° to about 78° Fahrenheit. In some embodiments, the water holding capacity is referred to the amount of water a soil can hold for crop consumption. In some embodiments, the water holding capacity is measured in units of % mass of total media mass. In some embodiments, the water holding capacity is measured in units of % volume of total media volume. In some embodiments, the soil has electrical conductivity.

Media Components include but are not limited to the following factors: a) Coconut Coir; b) Sphagnum Peat Moss; c) Perlite; d) Vermiculite; e) Dolomitic Lime; f) Gypsum; and g) general soil and organic amendments. In some embodiments, coconut coir is derived from the coconut fruit, more specifically the mesocarp and exocarp of the fruit. The fibers are shredded and soak in water baths to reach a predetermined EC. In some embodiments, coconut coir is soaked in Calcium-Nitrate. In some embodiments, coconut coir has high water holding capacity. In some embodiments, coconut coir has high CEC. In some embodiments, coconut coir has an 80:1 Carbon to Nitrogen Ratio. In some embodiments, sphagnum peat moss comprises of highly decomposed peat moss, which has about 30:1 to about 50:1 Carbon to Nitrogen Ration.

In some embodiments, perlite comprises amorphous volcanic glass heated, dehydrated and expanded over fifteen (15) times of the original volume. When expanded, perlite has nearly zero water holding capacity, and is a great source of aeration in commercial media mixes. In some embodiments, vermiculite comprises of hydrous, silicate mineral exfoliated causing expansion. When expanded, vermiculite has high water holding capacity. Vermiculite is used in commercial media mixes to increase water holding capacity of a mix while unchanging and often providing aeration. In some embodiments, Dolomitic Lime comprises of calcium magnesium carbonate, which is used in soil media mixes to buffer rhizosphere pH and used to supply magnesium. In some embodiments, Gypsum comprises calcium sulfate dihydrate, which is used to buffer soil conditions and provide calcium.

In some embodiments, general soil and organic amendments include a soil amendment so that any material added to a soil is to improve its physical properties, such as water retention, permeability, water infiltration, drainage, aeration and structure. The goal is to provide a better environment for roots (CSU). Organic amendments are derived from a living source, which increase the soil/media organic matter. Organic amendments also increase media aeration, water infiltration, nutrient holding capacity and water holding capacity. Inorganic amendments come from mined and manufactured materials, such as fertilizer salts, which improve many soil properties.

### Soil Usage and Plant Density

The assumption is that 1000 watts covers about an area of about 16 ft² (4′×4′ area), which results in 62.5 watts/ft². The standard nursery recommended for the amount of soil needed for a unit time is 1 gallon soil/month. On an equal-distantly spaced tray the following considerations are applied: with a 5 Gallon Final Pot, 3.7-4.3 cannabis plants are planted per 1000 watt fixture with correct stages of growth, pot spacing and vegetative duration. The following calculations serve as guidelines for the gallons of soil needed to fill a given area (A): 3.7 plants/1000 watt×(4.5 gallons/plant)=16.65 gal/1000 watt; 16.65 gal/1000 watt=16.65 gal/16 ft²=1.04 gal/ft²; (B) 4.3 plants/1000 watt×(4.5 gallons/plant)=19.35 gal/1000 watt; 19.35 gal/1000 watt=19.35 gal/16 ft²=1.2 gal/ft².

Given that 1.04 gal/ft² to 1.2 gal/ft² are needed, the total square footage of flower tray to be filled by both values are multiplied to get the upper and lower limits of the gallons per stage. With a 4 Gallon Final Pot, 5.55-6.45 cannabis plants are planted per 1000 watt fixture with correct stages of growth, pot spacing and vegetative duration. The following calculations serve as guidelines for the gallons of soil needed to fill a given area (A): 5.5 plants/1000 watt×(3 gallons/plant)=16.5 gal/1000 watt; 16.5 gal/1000 watt=16.5 gal/16 ft²=1.03125 gal/ft² B): 6.4 plants/1000 watt×(3 gallons/plant)=19.2 gal/1000 watt; 19.2 gal/1000 watt=19.2 gal/16 ft²=1.2 gal/ft².

### Header Design

The header design as described is unique in a few ways. The header is designed with a specific flow rate to provide an irrigation time of about 40 to about 45 minutes. In some embodiments, this is due to the choice of soil mixture. The soil mixture allows for about 3 to 5 days of water retention and in regards to overwatering, it is surprisingly difficult to mal-nourish the plant by providing water in too often of a frequency.

The porosity of the soil mixture also achieves an efficiency not felt by similar hydroponic systems (e.g., ebb and flood or drip) by using less water per irrigation and having less irrigation events. The purpose of watering within 45 minutes is that it is the fastest irrigation time in which the soil mixture ‘wicks’ water through capillary action, thus the objective is to create an irrigation time only the length required as to not be wasteful.

The soil mixture is proprietary in design. The irrigation time can also be due to achieving a facility design that allows all plants to have their first watering with the first (3) hours of metabolism, which is the time in plant physiology observed to be the most productive and providing ideal plant health care at this moment is pivotal.

In some embodiments, the header is designed to filter the water of any contaminates and provide this described pace of irrigation. In some embodiments, the header consists of a pre-filter (¾″ low micron filter; <120 micron), a pressure reducing, inline fitting (depending on system size is 10-15 PSI outlet), and actual header (1.5″ PVC×5′ piping with dual drip tape connection).

In some embodiments, the drip tape that connects to the header has pressure compensating emitters woven into the drip tape that are slightly less flow rate than 10 PSI. This design change in PSI allows the drip tape to quickly fill with even pressure through the whole system providing even water dispersion, which also allows all the plants to be watered at the same time, thus reducing the volume of water used and increasing efficiency.

### Pot Selection

Pot Selection is determined by the amount of time that is going to be spent in the potted media, including but not limited to a) standard agricultural production, which allows for 1 gallon of soil for each month of potted production; b) final pot selection is determined by the duration of the flowering cycle (typically 60 days) plus the duration spent in vegetative phases (i.e., (the total flower day duration+vegetative day duration)/(30 days)=the months in flower); c) a selection is made based on the available size pots: i) if production is 4 months a 5 gallon pot is required, ii) if production is 3 months a 4 gallon pot is required; iii) Base determination of true volumetric size of container; and d) vegetative pot selection is based on the following factors: i) the final stage(s) of vegetative growth are always in the in final production pot; ii) most production square footage and agronomics doesn't permit more than one transplant; and iii) initial pot size must be large enough for the cultivation duration.

### Nutrition and Fertilizer Salts

Whether a fertilizer element is mobile or immobile within the plant tissue in combination with other visual symptoms can give many clues to specific fertilizer deficiencies and toxicities. Being a mobile nutrient means the essential element can pass through plant tissue and be allocated where new tissues are forming. Immobile nutrients are locked in place once allocated to plant tissue during growth. Mobile nutrients because they are able to transport through plant tissues deficiencies appear in the lower plant portions first. With immobile nutrients, deficiencies appear in the younger tissue first (newer growth).

The mobile nutrients include but are not limited to: Nitrogen, which helps form amino acids (proteins), enzymes and RNA and DNA; Potassium, which is required to assist protein activity in over 40 proteins and a crucial cation in maintaining electrical balance and maintaining turgor; Magnesium, which is required by many enzymes and to transfer phosphate and a primary component of chlorophyll; Phosphorus, which is crucial in making RNA and DNA, help support active transport and is key part of sugars; Chlorine, which is required for photosynthesis; Sodium, which can substitute potassium in some function of metabolism; Zinc, which helps to form new molecules during photosynthesis and metabolism; and Molybdenum, which helps utilize nitrogen.

The immobile nutrients include but are not limited to: Calcium, which is a main component of the cell wall and is required in active transport and helps regulate metabolism; Sulfur, which is a crucial part of key proteins and enzymes; Iron, which is involved in light reception in chlorophyll; Boron, which is pivotal in supporting the cell wall; Copper, which is crucial in forming new molecules; and Manganese, which is heavily involved in cell divisions and cell changes and is a major component of forming proteins and new molecules.

In some embodiments, fertilizer elements are further defined by there need in terms of quality. There relative need to the least required nutrient by concentration, molybdenum, and the average % or ppm in average plant dry matter is what determines the classification as either a macronutrient or micronutrient.

In some embodiments, macronutrients can either be taken up from the media or found in water or brought in through stomata as carbon dioxide. The macronutrients found in water and carbon dioxide is carbon, oxygen and hydrogen. In that order, these are the most needed elements essential for plant growth. The remaining macronutrients are found in the media. In order of need, they are nitrogen, potassium calcium, magnesium, phosphorus, sulfur and silicon. The remaining nutrients are classified as micronutrients. They are essential and are as follows; chlorine, iron, boron, manganese, sodium, zinc, copper, nickel and molybdenum.

In some embodiments, an essential element is needed as a major constituent or to complete the life cycle of the plant. A beneficial nutrient may enhance the growth of the plant through a variety of different mechanisms including but not limited to: disease resistance, enhance nutrient availability, mimic plant hormones, encourage beneficial rhizosphere associations with microorganisms, and confer stress resistance.

In some embodiments, fertilizer salts are either taken in by the roots as a specific element or compound, through water or as carbon dioxide. Nitrogen is taken in through the roots as nitrate and ammonium (NO₃⁻ and NH₄⁺), hydrogen and oxygen through water (H₂O), potassium as a cation (K⁺), along with Calcium (Ca²⁺), Magnesium (Mg2+), chelated (Fe²⁺ or Fe³⁺), Zinc (Zn²⁺), manganese (Mn²⁺), copper (Cu²⁺ or Cu⁺) and molybdenum (Mo⁴+ and Mo⁶⁺). Phosphate is taken up as PO₄³⁻. Chealtors or chelating agents, increase the availability of cations.

Throughout the life cycle of the cannabis plant the nutritional requirements continually change. During the vegetative phases, cannabis prefers a nutritional profile that provides elements such as nitrogen calcium and iron in higher ratios than in later stages of growth and flowering phases. When the cannabis plant enters the flowering phases again the nutritional requirements begin to change. Relative to vegetative growth, the plant now prefers greater amounts of phosphorous, potassium and magnesium. This promotes the enzymatic reactions that drive flower growth. At the final stage of growth, flushing occurs. This is a leaching of the soil to remove any potential heavy metals and excess fertilizer salts. The nutritional profile now generally reflects an electoral conductivity as close to zero as possible. Chelating agents can promote the leeching of salts.

In some embodiments, soil fertility is essential to providing the nutrients needed for vigorous growth and flowering. Continuous monitoring of the conductivity and pH allows for plant productivity. pH and EC monitoring begin with sampling the soil electro-conductivity and pH of plants in production of the proper moisture. In some embodiments, sample table with Hanna EC probe enables the calibration of EC probe at least once a month; ensures good contact between the probe and the media; samples the root zone of the plant, not the surrounding soil area; and samples when adequate moisture in pot.

In some embodiments, dry pots might yield lower-than-actual fertility readings, and give inaccurate reading if there is not adequate moisture in the pot. In some embodiments, recently watered pots yield artificially high readings, thus wait 1 to 2 days to sample top watered pots after watering and wait minimum 3 to 4 hours to sample capillary mat pots after watering. In some embodiments, sample table with RapiTest Soil pH Tester ensures probe is perpendicular to soil surface; ensures probe is deeply placed in soil to avoid air pockets and pot edges or bottom; ensures pot has adequate moisture, which references soil EC moisture levels. In some embodiments, data, such as date, morphological stage (vegetative vs. flower), tray number, growth stage, soil EC, and soil pH, are recorded for pH/EC of several plants in different areas (around 6-10 plants).

General Fertility Values (Hanna EC Soil Probe) is as follows: a)<0.25 is Deficient; b) 0.25-0.4 is Hidden Hunger; c) 0.41-0.59 is Optimal; d) 0.6-0.7 is Luxury; e) 0.7-0.9 is High; and f) >1.0 is Excessive.

### Feed Strength

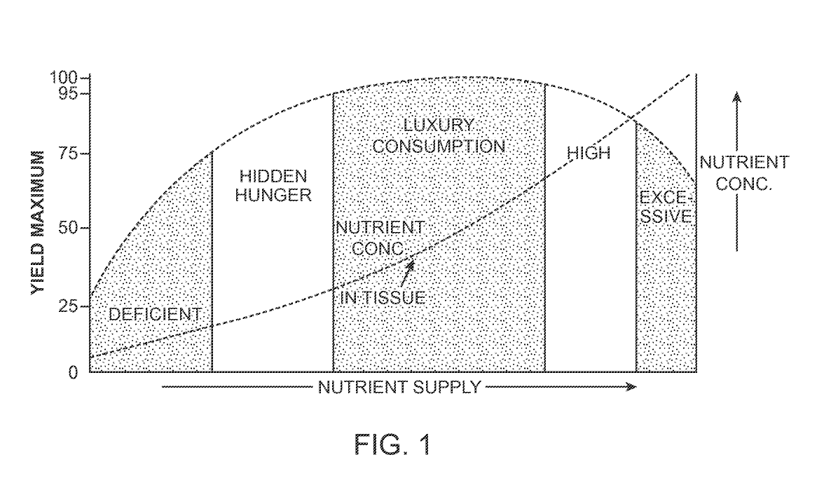

Feed strength reference chart as shown in FIG. 1 involves fertilization consumption ranges, nutrient supply and concentration, and yield maximum. Using the recorded data for pH/EC, such as date, morphological state (vegetative vs. flower), tray number, growth stage, soil EC, and soil pH to determine the fertility values.

After watering, if the fertility value is excessive, the plants are flushed with RO water with 25-50% leeching, depending on severity, and the fertility value is retested and adjusted accordingly. If the fertility value is high, the mix strength is decreased 10-15% by adding water or making a new batch tank in capillary mats, or the mix strength is decreased 15-25% by adding water or making a new batch tank using the top water method.

If the fertility value is luxury, the mix strength is decreased 5-10% by adding water or making a new batch tank in capillary mats, or the mix strength is decreased 10% by adding water or making a new batch tank using the top water method. If the fertility value is optimal, the feed strength is maintained. If the fertility value is hidden hunger, the mix strength is increased by 5-10% using capillary mats, or 10% using top water method. If the fertility value is deficiency, the feed strength is increased by 10-15% using capillary mats or top water method. The appropriate feed strength for the pot is strongly dependent on plant water use. In the presence of certain environmental conditions, ideal fertilizer strengths change.

### Flushing

In some embodiments, flushing is required any time fertility values above 0.9 mS on the Hanna EC probe, top flush with RO water with 25-50% leeching, depending on the fertility values. In some embodiments, plants are flushed on Capillary mats at four (4) weeks in flower with R.O. water with a top feed around 50% leaching.

In some embodiments, seven (7) days before the end of flower period, if the EC readings in pots is above 0.1, adequate amounts of water is run through to bring the EC down to the desired level. In some embodiments, flushing begins at Day fourteen (14) before harvest for 60 days facilities and Day thirteen (13) before harvest for 56 days facilities.

In some embodiments, plant fertilization, pH, fertigation EC and temperature are tracked in combination with date, morphological stage (vegetative vs. flower), tray number, growth stage, mix EC, mix pH, and mix temperature.

It is to be understood that while the present disclosure has been described in conjunction with the above embodiments, that the foregoing description and examples are intended to illustrate and not limit the scope of the present disclosure. Other aspects, advantages and modifications within the scope of the present disclosure will be apparent to those skilled in the art to which the present disclosure pertains.

The present disclosure is not to be limited in scope by the specific embodiments described which are intended as single illustrations of individual aspects of the present disclosure, and any compositions or methods, which are functionally equivalent are within the scope of this disclosure. It will be apparent to those skilled in the art that various modifications and variations can be made in the methods and compositions of the present disclosure without departing from the spirit or scope of the disclosure. Thus, it is intended that the present disclosure cover the modifications and variations of this disclosure provided they come within the scope of the appended claims and their equivalents.

All publications and patent applications mentioned in this specification are herein incorporated by reference to the same extent as if each individual publication or patent application was specifically and individually indicated to be incorporated by reference.

What is claimed is:

1. A method for cultivating cannabis under conditions wherein the cannabinoid components expressed by a cannabis plant are subject to plasticity, wherein said method comprises irrigating the cannabis plant using a capillary mat, wherein said capillary mat is capable of simultaneously irrigating said cannabis plant and delivering a selected set of nutrients for cultivation to said cannabis plant, wherein variation of said selected set of nutrients or concentration of said selected set of nutrients is provided under controlled and reproducible conditions by said capillary mat so as to provide plasticity to express substantially the same cannabinoid components within said cannabis plant.

2. The method of claim 1, wherein said method further comprises delivering a selected set of nutrients for cultivation to said cannabis plant using said capillary mat.

3. The method of claim 1, wherein variation of said selected set of nutrients or concentration of said selected set of nutrients is provided to increase cannabinoid content while lowering THC content within said cannabis plant.

4. The method of claim 1, the method further comprises using the capillary mats to maintain an optimal pH within a growth media of said cannabis plant.

5. The method of claim 1, wherein the method further comprises using said capillary mat for flushing a growth media of said cannabis plant.

6. The method of claim 1, wherein variation of said selected set of nutrients comprises providing nutrients at levels varying from deficient to excessive.

7. The method of claim 1, wherein the method further comprises irrigating the cannabis plant from above a growth media of said cannabis plant at regular intervals.

8. The method of claim 7, wherein irrigating the cannabis plant from above the growth media of said cannabis plant comprises providing a solution above the growth media with a nutrient concentration less than that being provided by the capillary mat.

9. The method of claim 1, wherein irrigating the cannabis plant using a capillary mat comprises providing water to said cannabis plant in pulsed durations.

10. The method of claim 1, further comprising control of fungal and pathogen proliferation within said capillary mat.

11. The method of claim 1, wherein the average amount of water per day irrigated by said capillary mat is between about 0.2 gallons/square foot and 0.4 gallons/square foot.

12. The method of claim 1, wherein the capillary mat comprises cotton, wool, polyethylene or polypropylene.
